(19) United States
(12) Patent Application Publication
(10) Pub. No.: US 2019/0240853 A1
(43) Pub. Date: Aug. 8, 2019

(54) ROTARY CUTTER SAFETY INSERT

(71) Applicant: Bennett Alan Mortensen, Cedaredge, CO (US)

(72) Inventor: Bennett Alan Mortensen, Cedaredge, CO (US)

(21) Appl. No.: 15/890,149

(22) Filed: Feb. 6, 2018

(51) Int. Cl. B26B 21/18; D06H 7/00; B26B 29/02; B26B 25/00

(52) U.S. Cl. CPC B26B 21/185; B26B 25/005; B26B 29/02; D06H 7/00

(57) ABSTRACT

A rotary cutter insert can include a body configured to cover a first portion of a surface of a rotary blade. Further, the body of the rotary cutter insert can have an angled cutout configured to expose a second portion of the surface of the rotary blade so a rotary cutter can be used while the rotary cutter insert is in place. The rotary cutter insert reduces the area of exposed rotary blade that could potentially injure a user, thus making the rotary cutter significantly safer.

### BACKGROUND

Sewing and crafting enthusiast often employ the use of rotary cutters to cut textiles and similar materials. Unfortunately, the circular rotary blades can be dangerous for users. Manufacturers of rotary cutters often include a sliding blade guard that covers the blade while the rotary cutter is not in use. However, sliding blade guards are generally not designed to cover the blade while rotary cutter is in use, and therefore the blade can still present a risk of injury to users while they use the rotary cutter. Accordingly, there are problems in the art that can be addressed with respect to rotary cutter safety.

### BRIEF SUMMARY

Embodiments of the present disclosure solve one or more problems in the art with an insert configured to protect a user from the blade of a rotary cutter. In particular, in at least one embodiment, the insert includes a body configured to cover a first portion of a surface of the rotary blade. Further, the body of the insert can have an angled cutout configured to expose a second portion of the surface of the rotary blade so the rotary cutter can be used while the insert is in place. The insert reduces the area of exposed blade that could potentially injure a user, thus making the rotary cutter significantly safer.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1A illustrates a first side perspective view of an exemplary rotary cutter with a rotary cutter insert installed;

FIG. 1B illustrates a second side perspective view of the exemplary rotary cutter shown in FIG. 1A;

FIG. 2A illustrates a first side perspective view of an exemplary rotary cutter with a rotary cutter insert installed;

FIG. 2B illustrates a second side perspective view of the exemplary rotary cutter shown in FIG. 2A;

FIG. 3 shows a front exploded view of an exemplary rotary cutter with a rotary cutter insert installed;

FIG. 4A illustrates a side perspective view of an exemplary rotary cutter insert;

FIG. 4B illustrates a bottom perspective view of the exemplary rotary cutter insert shown in FIG. 4A;

FIG. 5A illustrates a side perspective view of an exemplary rotary cutter insert;

FIG. 5B illustrates a bottom perspective view of the exemplary rotary cutter insert shown in FIG. 5A;

FIG. 6A illustrates a first side perspective view of an exemplary rotary cutter insert;

FIG. 6B illustrates a second side perspective view of the exemplary rotary cutter insert shown in FIG. 6A; and

FIG. 6C illustrates a back-perspective view of the exemplary rotary cutter insert shown in FIGS. 6A and 6B.

### DETAILED DESCRIPTION

The present disclosure extends to an insert configured to cover the blade of a rotary cutter. In particular, the insert covers the surface of the rotary blade except for an angled cutout that is designed allow the user to use the rotary cutter while the insert is in place. The insert reduces the area of exposed blade that could potentially injure a user, thus making the rotary cutter significantly safer.

In addition, the rotary cover insert is easy to install on a rotary cutter. Rotary cutters generally have replaceable blades, and are therefore made to dissemble easily so users can replace old or worn blades. The user can install the insert by disassembling the rotary cutter as if the user was replacing the blade, and simply placing the insert between the blade and the rotary cutter body before reassembling the rotary cutter. Further, unlike sliding or rotating blade guards, the present disclosure does not need to be moved before using the rotary cutter.

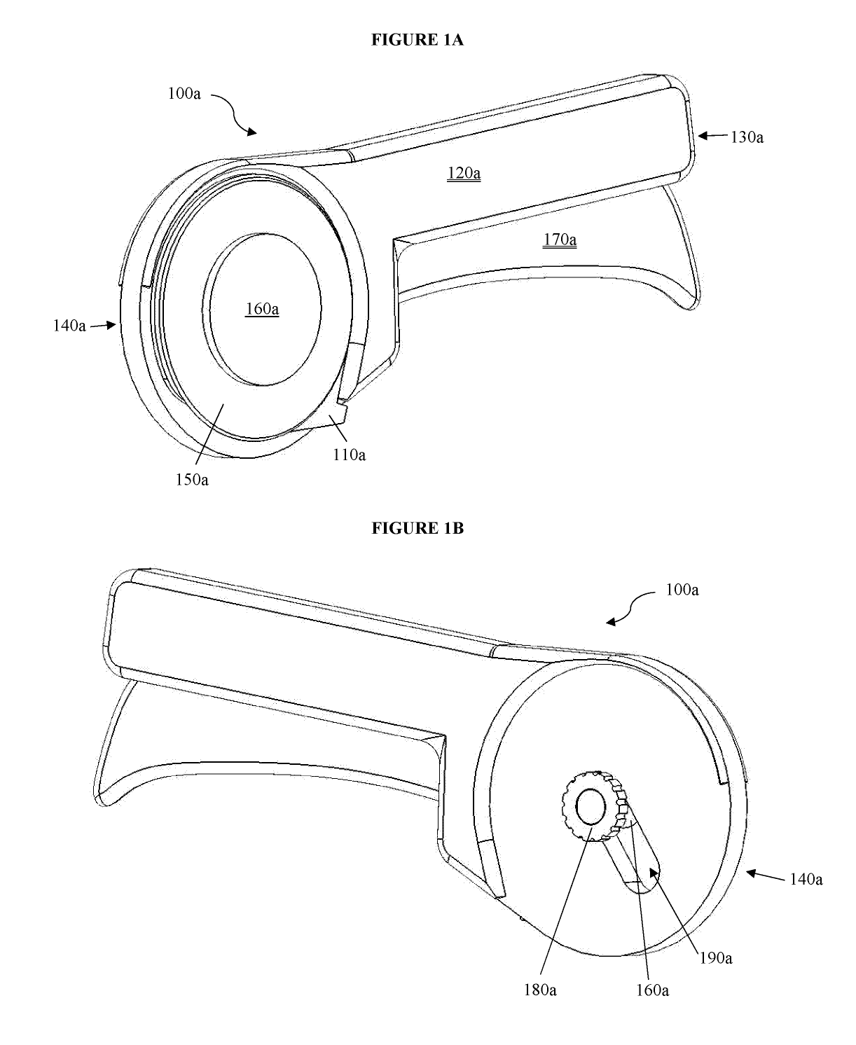

FIGS. 1A and 1B show an exemplary rotary cutter 100a with a rotary cutter insert 110a installed. As shown, the rotary cutter 100a includes a rotary body 120a with a proximal end 130a and a distal end 140a. FIG. 1A further shows that the distal end of the rotary body 140a includes a rotary blade 150a positioned lateral to the rotary cutter insert 110a, and an attachment mechanism 160a that secures the rotary cutter insert 110a and the rotary blade 150a to the distal end of the rotary body 140a of the rotary cutter 100a. The rotary cutter 100a can also include a lever 170a, which when engaged, causes the attachment mechanism 160a, rotary cutter insert 110a, and rotary blade 150a to slide into a position where rotary blade 150a can be used.

FIG. 1B shows the opposing side of the rotary cutter 100a shown in FIG. 1A. As shown, on the opposing side, the distal end of the rotary body 140a includes fastening mechanism 180a that engages with the attachment mechanism 160a to secure the rotary cutter insert 110a and rotary blade 150a to the rotary cutter 100a. FIG. 1B also shows the sliding plane 190a along which the fastening mechanism 180a, the attachment mechanism 160a, rotary cutter insert 110a, and the rotary blade 150a slide when the lever 170a is engaged.

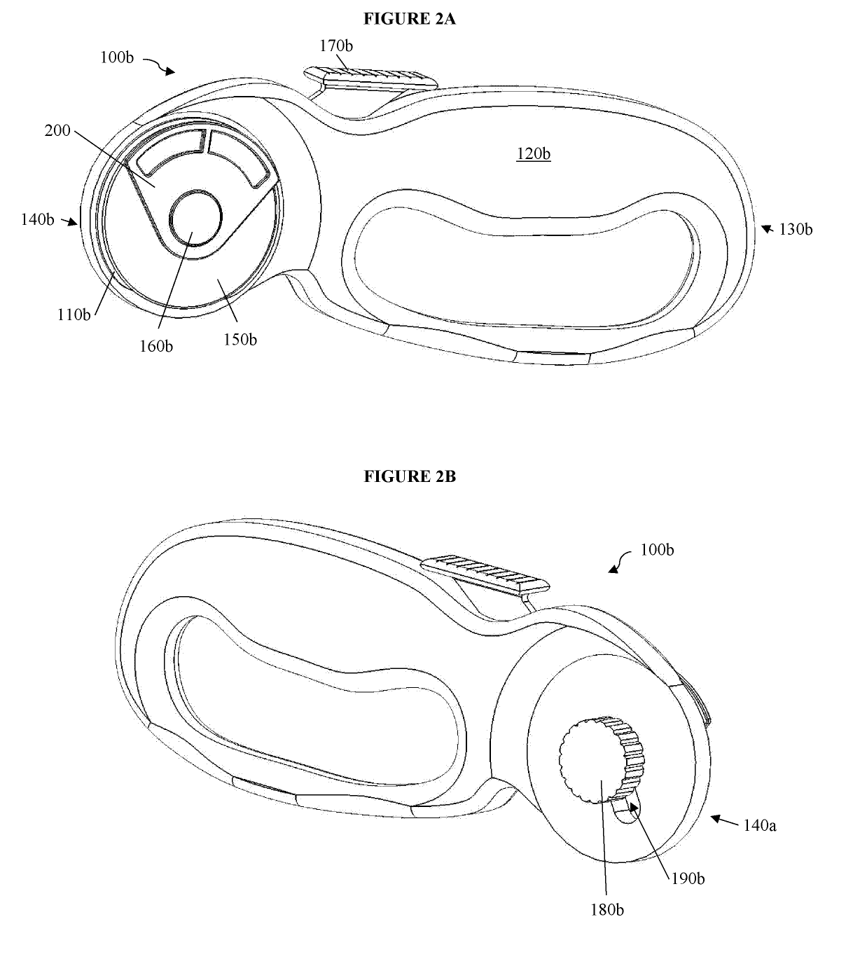

FIGS. 2A and 2B show an alternative exemplary rotary cutter 100b with a rotary cutter insert 110b installed. Like the rotary cutter 100a shown in FIGS. 1A-1B, the rotary cutter 100b includes a rotary body 120b with a proximal end 130b and a distal end 140b. The distal end of the rotary body 140b further comprises a rotary blade 150b on the lateral side of the rotary cutter insert, and an attachment mechanism 160b to secure the rotary cutter insert 110b and rotary blade 150b to the rotary cutter 100b. The attachment mechanism can also secure a blade guard 200 on the lateral side of the rotary blade 150b to the rotary cutter 100b. The rotary cutter 100b also includes a 170b that when engaged, causes the attachment mechanism 160b, rotary cutter insert 110b, rotary blade 150a, and blade guard 200 to slide into a position where rotary blade 150b can be used.

FIG. 2B shows the opposing side of the rotary cutter 100b shown in FIG. 2A. As shown, on the opposing side, the distal end of the rotary body 140b includes fastening mechanism 180b that engages with the attachment mechanism 160b to secure the rotary cutter insert 110b, rotary blade 150b, and blade guard 200 to the rotary cutter 100a. FIG. 2B also shows the sliding plane 190b along which the fastening mechanism 180b, the attachment mechanism 160b, rotary cutter insert 110b, the rotary blade 150b, and blade guard 200 slide when the lever 170a is engaged.

FIGS. 1A and 2A show how the rotary cutter insert 110 surrounds all but a portion of the rotary blade 150. When the lever 170 is engaged, and the rotary blade 150 slides into a position where it can be used (e.g. outside the perimeter of the distal end of the rotary body 140), the rotary cutter insert 110 continues to cover all but a portion of the rotary blade 150. Even when the rotary blade 150 is in a position where it can be used, the rotary cutter insert 110 covers all but the portion of the rotary blade 150 necessary to cut. The reduced exposed blade area of the rotary blade 150 makes the rotary cutter 100 safer to use.

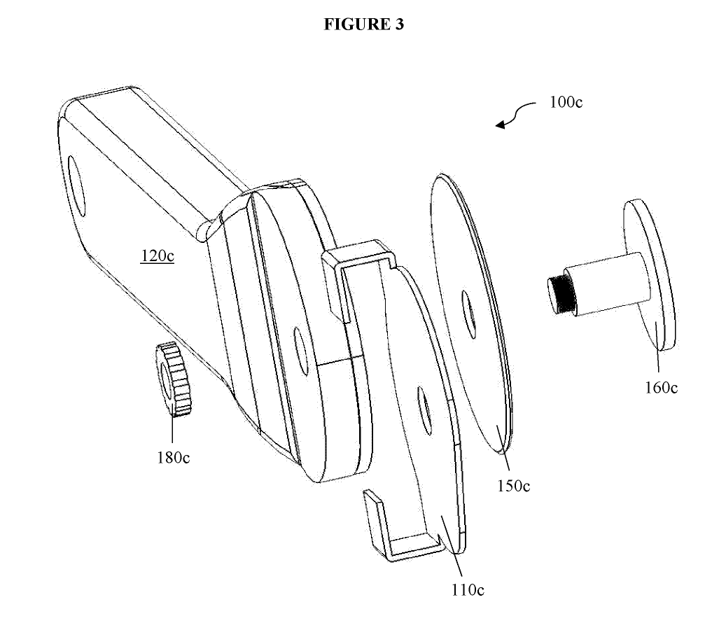

FIG. 3 shows an exploded view of exemplary rotary cutter 100c. As shown, the manufacturer or user can put the rotary cutter insert 110c between the rotary body 120c and the rotary blade 150c. The rotary cutter insert 110c and rotary blade 150c can be secured to the rotary body 120c using the attachment mechanism 160c and the fastening mechanism 180c. Although FIG. 3 shows the rotary cutter insert 110c between the rotary body 120c and rotary blade 150c, the present disclosure is not so limited. In at least one implementation, the rotary cutter insert 110c is positioned on the lateral side of the rotary blade 150c.

The rotary cutters 100 in FIGS. 1A-3 are not limited to the, size, shape, configurement, etc. shown in FIGS. 1A-3. Not all the features shown in FIGS. 1A-3 must be present. For example, the rotary cutter may not have a lever 170. There may also be additional features included on the rotary cutters 100 that are not shown in the Figures. Further, although FIGS. 1A-3 show the rotary cutter inserts 110 and rotary blades 150 on the right side of the rotary body 120 from the user's perspective, one skilled in the art will appreciate that the present disclosure is not so limited. The rotary cutter insert 110 and rotary blade 150 can be on the right or left side of the rotary body 120.

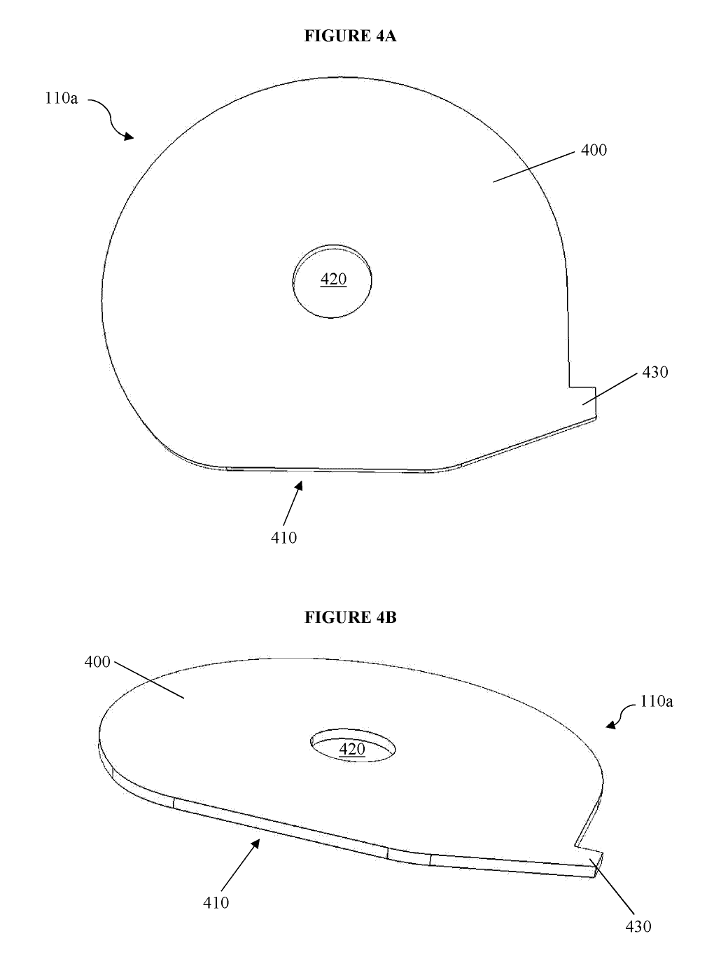

FIGS. 4A and 4B show an exemplary rotary cutter insert 110a similar to that shown in FIGS. 1A and 1B. As shown, the rotary cutter insert 110a includes a body 400, an angled cutout 410, a central hole 420, and a stabilizing notch 430. The body 400 has an angled cutout 410 configured to expose only the portion of the rotary blade needed to cut. The rotary cutter insert 110a includes a central hole 420 that allows the manufacturer or user to attach the insert 110a to the rotary cutter. The stabilizing notch 430 is designed to stabilize the insert 110a when the insert 110a is attached to the rotary cutter.

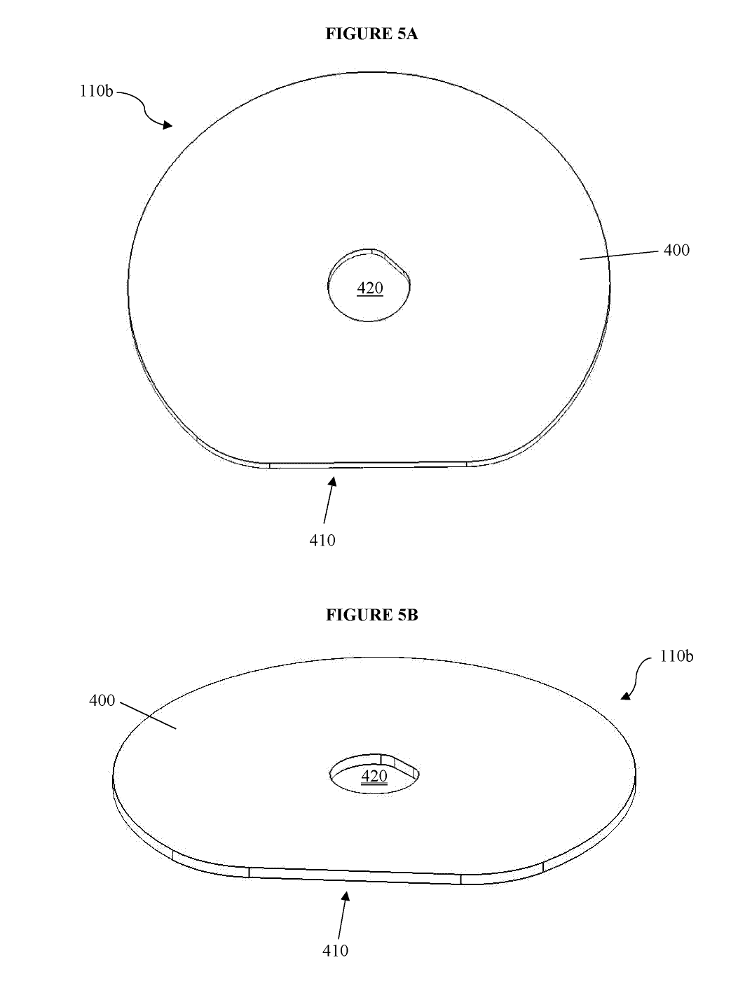

FIGS. 5A and 5B show an exemplary rotary cutter insert 110b similar to the rotary cutter insert 110b shown in FIGS. 2A and 2B. The rotary cutter insert 110b includes a body 400, an angled cutout 410, and a central hole 420. Like the body 400 shown in FIGS. 4A and 4B, the body 400 in FIGS. 5A and 5B have an angled cutout 410 configured to expose only the portion of the rotary blade needed to cut. The central hole 420 is configured to allow the manufacturer or user to attach the rotary cutter insert 110b to the rotary cutter.

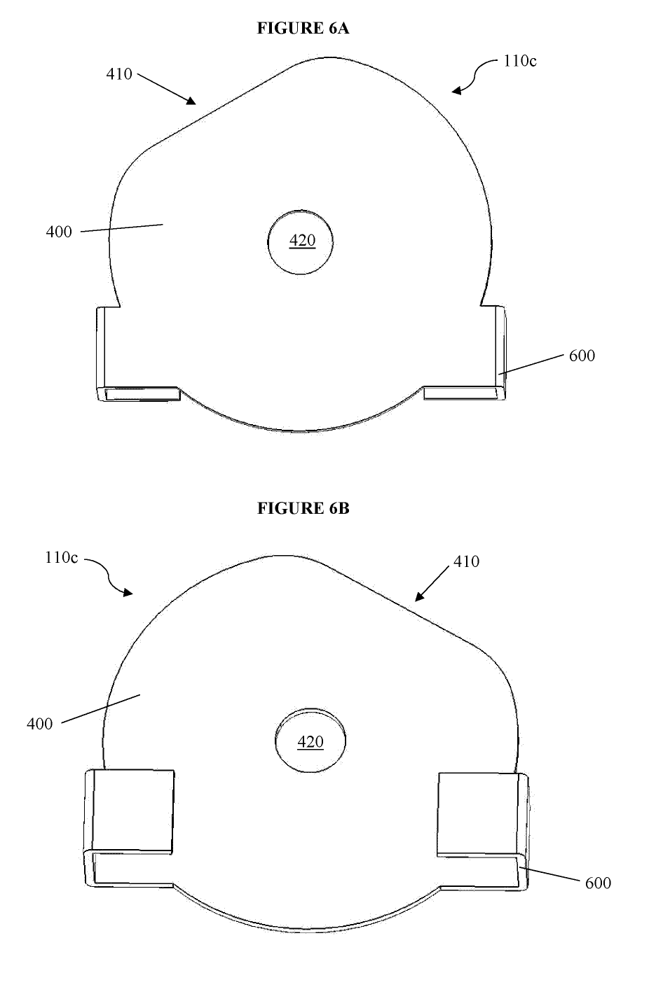

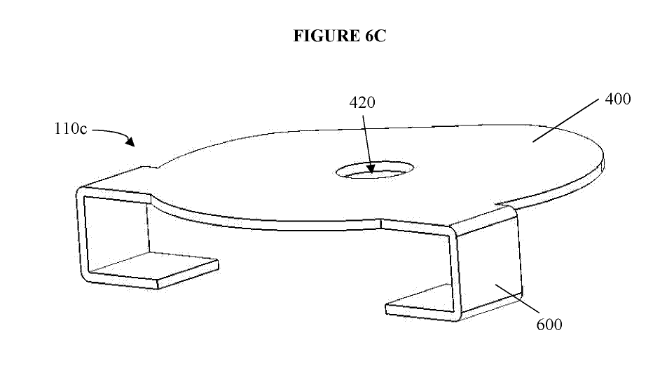

FIGS. 6A-6C show an exemplary rotary cutter insert 110c similar to that shown in FIG. 3. As shown, the rotary cutter insert 110c can include a body 400, an angled cutout 410, a central hole 420, and attachment arms 600. As shown, the body 400 has an angled cutout 410 configured to expose only the portion of the rotary blade needed to cut. The insert 110c includes a central hole 420 that allows the manufacturer or user to attach the insert 110c to the rotary cutter. The attachment arms 600 stabilize the insert 110c when the insert 110c is attached to the rotary cutter. The shape and size of the attachment arms 600 are not limited to those shown in FIGS. 6A-6C.

One skilled in the art will appreciate that the rotary cutter insert 110 may be manufactured out of any suitable plastic, metal, or organic material. In at least one implementation, the rotary cutter insert 110 is made of acrylic. In alternative embodiments, the rotary cutter insert 110 is made of polycarbonate, polyvinylchloride, polyamid, cellulosic, styrene, polyethylene, or any other thermoplastic.

Further, one skilled in the art will appreciate that bodies 400 are not limited to the size and circular shape shown in FIGS. 4A-6C. In at least some embodiments, the width of the body 400 is within the range of ¼^{th} to 5 mm. The manufacturer can size the body 400 to cover a 28 mm, 45 mm, or 60 mm rotary blade. In at least one additional or alternative implementation, the length of the body 400 is within the range of 10 to 100 mm.

The size of the central hole 420 is also not limited to that shown in FIGS. 4A-6C. The diameter of the central hole 420 may vary depending on the securing means used to attach the rotary blade and the rotary cutter insert 110 to the rotary cutter. FIGS. 4A-4B and 6A-6C show a circular central hole 420, while FIGS. 5A-5B show a semi-circular central hole 420. The shape of the central hole 420 may be any shape suitable to allow the attachment of the rotary cutter insert 110 to the rotary cutter. Further, in at least one alternative embodiment, the rotary cutter insert 110 does not have a central hole 420. The manufacturer or user can use any means that allows the attachment of the rotary cutter insert 110 to the rotary cutter. One skilled in the art will further appreciate that the angle of the angled cutout 410 is not limited to that shown in FIGS. 4A-6C.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A rotary cutter insert comprising:
a body configured to cover a first portion of a surface of a rotary blade, wherein the body has an angled cutout configured to expose a second portion of the surface of the rotary blade.

2. The rotary cutter insert of claim 1, further comprising a central hole configured to enable a reversible attachment of the rotary cutter insert to a rotary cutter.

3. The rotary cutter insert of claim 2, wherein the central hole is circular.

4. The rotary cutter insert of claim 2, wherein the central hole is semi-circular.

5. The rotary cutter insert of claim 1, further comprising a stabilizing mechanism configured to secure the rotary cutter insert to the rotary cutter.

6. The rotary cutter insert of claim 5, wherein the stabilizing mechanism comprises attachment arms.

7. The rotary cutter insert of claim 5, wherein the stabilizing mechanism comprises a stabilizing notch.

8. The rotary cutter insert of claim 1, wherein the rotary cutter insert is made of acrylic.

9. The rotary cutter insert of claim 1, wherein the rotary cutter insert is made of thermoplastic.

10. The rotary cutter insert of claim 1, wherein the body of the rotary cutter insert is configured to cover a 28 mm rotary blade.

11. The rotary cutter insert of claim 1, wherein the body of the rotary cutter insert is configured to cover a 45 mm rotary blade.

12. The rotary cutter insert of claim 1, wherein the body of the rotary cutter insert is configured to cover a 60 mm rotary blade.

13. The rotary cutter insert of claim 1, wherein the width of the body of the rotary cutter insert is within the range of ¼^{th} to 5 mm.

14. The rotary cutter insert of claim 1, wherein the length of the body of the rotary cutter insert is within the range of 10 to 100 mm.

15. A rotary cutter insert comprising:
a circular body configured to cover a first portion of a surface of a rotary blade, wherein the circular body has an angled cutout configured to expose a second portion of the surface of the rotary blade; and
a central hole configured to enable an attachment of the rotary cutter insert to a rotary cutter, wherein the rotary cutter insert is configured to reversibly attach to the rotary cutter between a rotary cutter body and the rotary blade.

16. A method for assembling a rotary cutter comprising:
providing a rotary cutter insert comprising a body configured to cover a first portion of a surface of a rotary blade, wherein the body has an angled cutout configured to expose a second portion of the surface of the rotary blade; and
reversibly securing the rotary cutter insert and the rotary blade to a rotary cutter.

17. The method of claim 16, wherein the rotary cutter insert is reversibly secured between the rotary blade and the rotary cutter.

18. The method of claim 16, wherein the rotary cutter insert further comprises a central hole configured to enable the rotary cutter insert to be reversibly secured to the a rotary cutter.

19. The method of claim 16, wherein the rotary cutter insert further comprises a stabilizing mechanism configured to secure the rotary cutter insert to the rotary cutter.

20. The method of claim 16, wherein a blade guard is reversibly secured to the rotary cutter.
